(19) United States
(12) Patent Application Publication
(10) Pub. No.: US 2013/0183438 A1
(43) Pub. Date: Jul. 18, 2013

(54) BATTERY ELECTRODE MANUFACTURING METHOD AND BATTERY ELECTRODE MANUFACTURING DEVICE

(71) Applicant: Shigeru Suzuki, Okazaki-shi (JP)

(72) Inventor: Shigeru Suzuki, Okazaki-shi (JP)

(21) Appl. No.: 13/822,002

(22) PCT Filed: Sep. 13, 2010
(86) PCT No.: PCT/JP2010/065739

§ 371 Date: Mar. 11, 2013

(51) Int. Cl. H01M 4/04

(52) U.S. Cl. CPC H01M 4/0404
USPC 427/58; 118/419; 118/712

(57) ABSTRACT

Disclosed are a battery electrode manufacturing method and a battery electrode manufacturing device which improve yield in the battery electrode manufacture. The disclosed method for manufacturing battery electrode involves coating a transported current collector sheet with an electrode paste. A reduced-pressure chamber is arranged at the tip of a die where the aforementioned electrode paste is discharged, and the coating width of the aforementioned paste is controlled by changing the pressure of the aforementioned reduced-pressure chamber.

### TECHNICAL FIELD

The present invention relates to a battery electrode manufacturing method and a battery electrode manufacturing device to manufacture an electrode including a strip-shaped current collector sheet whose surface is coated with electrode paste.

### BACKGROUND ART

In manufacturing batteries such as secondary batteries, an electrode is produced in such a manner that electrode paste is consecutively coated and dried on a surface of a strip-shaped current collector sheet, and the produced electrode is wound to manufacture a battery.

In a step of consecutively coating the electrode paste on the surface of the strip-shaped current collector sheet, conventionally, a coating width of the electrode paste after coating is measured, a gap between a die to discharge the electrode paste and the current collector sheet is changed based on a measurement result of the coating width, and the gap is controlled to bring the coating width of the electrode paste to a desired value.

At that time, if the gap between the die and the current collector sheet is small, pressure loss at a lip portion which is an discharge port of the die increases, causing an increase in pressure in the lip portion. This causes the electrode paste to spread in a large area in a coating width direction, so that the coating width of the electrode paste is wide. If the gap between the die and the current collector sheet is large, pressure loss in the lip portion of the die decreases, causing the electrode paste to spread in a small area, so that the coating width of the electrode paste is narrow. Accordingly, the gap is controlled to control the coating width of the electrode paste to a desired coating width.

However, when the gap between the die and the current collector sheet is changed to control the coating width of the electrode paste, it takes long until the pressure of the lip portion of the die becomes stable. This needs much time to obtain a desired coating width. One reason of this is given below. The pressure in the lip portion varies according to changes in gap between the die and the current collector sheet. However, the pressure varies throughout the entire flow passage from an outlet of a pump to discharge the electrode paste to the lip portion of the die. Stabilization of the pressure throughout the passage takes much time.

The flow rate of the electrode paste to be discharged from the die becomes stable after the pressure in the lip portion is stabilized. It therefore takes more time until the coating width of the electrode paste on the current collector sheet reaches a desired coating width.

A portion of the current collector sheet, having been coated with the electrode paste before the coating width reaches the desired width, could not be used as an electrode of a battery. Accordingly, if it takes much time to obtain the desired coating width, a yield in the manufacture of battery electrodes decreases.

For example, as shown in FIG. 14, when the gap between the die and the current collector sheet is changed at the time h1, the pressure in the lip portion of the die becomes stable at the time h2 lagging the time h1, and further the coating width of the electrode paste (the flow rate of the electrode paste discharged from the die) becomes stable at the time h3 lagging the h2. Thus, a portion of the current collector sheet on which the electrode paste is coated in a time zone b following the time h4 (the time at which the desired coating width is confirmed by measurement of the coating width) further lagging the time h3 could be used as battery electrodes. However, another portion of the current collector sheet on which the electrode paste is coated in a time zone a before the time h4 could not be used as battery electrodes. Therefore, it is desired to control the coating width of the electrode paste to a desired coating width in a short time.

Herein, Patent Document 1 discloses that a pressure reducing chamber for reducing the pressure on an upstream side of a web from bead is provided at a tip of a die, an opening degree of a valve is adjusted based on a measurement result of a pressure gauge to keep the internal pressure of the pressure reducing chamber at a predetermined constant pressure.

### RELATED ART DOCUMENTS

### Patent Documents

Patent Document 1: JP-A-2006-272130

### SUMMARY OF INVENTION

### Problems to be Solved by the Invention

However, in the technique of Patent Document 1, in which the internal pressure of the pressure reducing chamber is kept at the predetermined constant pressure. Thus, when the coating width of the bead varies by coating environmental changes or the like, the coating width of the bead could not be controlled to a desired width. Therefore, the bead could not be coated with a desired coating width on the web. This decreases the yield in the manufacture of webs coated with bead.

The present invention has a purpose to provide a battery electrode manufacturing method and a battery electrode manufacturing device arranged to increase the yield in the manufacture of battery electrodes.

### Means of Solving the Problems

To achieve the above purpose, one aspect of the invention provides a battery electrode manufacturing method for coating electrode paste on a current collector sheet to be fed, the method comprising the steps of placing a pressure reducing chamber at a tip of a die for discharging the electrode paste; and changing a pressure reduction degree of the pressure reducing chamber to control a coating width of the electrode paste.

According to the above configuration, the pressure reducing degree of the pressure reducing chamber is changed to control the coating width of the electrode paste. Thus, the coating width of the electrode paste is controllable to a desired width in a short time. This can shorten a coated portion of the current collector sheet applied with the electrode paste having a coating width narrower than the desired width. Therefore, the yield in the manufacture of battery electrodes can be improved.

In the above aspect, preferably, the method includes changing a suction amount of a blower connected to the pressure reducing chamber to change the pressure reduction degree.

According to this configuration, it is only necessary to adjust for example the inverter frequency of the blower. Thus, a simple configuration can be achieved.

In the above aspect, preferably, the method includes changing a distance between the pressure reducing chamber and the current collector sheet to change the pressure reduction degree.

According to this configuration, the coating width of the electrode paste can be controlled to a desired width in a shorter time than above. This can further improve the yield in the manufacture of battery electrodes.

In the above aspect, preferably, the method includes measuring the coating width and determining the pressure reduction degree according to the measured coating width.

According to this configuration, feedback control is performed based on a measurement value of the coating width. Thus, the coating width of the electrode paste is more accurately controllable to a desired width.

In the above aspect, preferably, the method includes measuring a viscosity of the electrode paste before the start of coating the electrode paste on the current collector sheet and setting the pressure reduction degree according to the measured viscosity.

According to this configuration, it is possible to control the coating width of the electrode paste to a desired width from the start of coating. Therefore, even a coating start portion of the current collector sheet applied with the electrode paste can be used for battery electrodes. This can further increase the yield in the manufacture of battery electrodes.

To achieve the above purpose, another aspect of the invention provides a battery electrode manufacturing device for coating electrode paste on a current collector sheet to be fed, the device comprising: a die to discharge the electrode paste; a pressure reducing chamber placed at a tip of the die; and a coating width controller to change a pressure reduction degree of the pressure reducing chamber to control a coating width of the electrode paste.

According to the above configuration, the pressure reducing degree of the pressure reducing chamber is changed to control the coating width of the electrode paste. Thus, the coating width of the electrode paste can be controlled to a desired width in a short time. This can shorten a coated portion of the current collector sheet applied with the electrode paste having a coating width narrower than the desired width. Therefore, the yield in the manufacture of battery electrodes can be increased.

In the above aspect, preferably, the coating width controller changes a suction amount of a blower connected to the pressure reducing chamber to change the pressure reduction degree.

According to this configuration, it is only necessary to adjust for example the inverter frequency of the blower. Thus, a simple configuration can be achieved.

In the above aspect, preferably, the coating width controller changes a distance between the pressure reducing chamber and the current collector sheet to change the pressure reduction degree.

According to this configuration,the coating width of the electrode paste is controllable to a desired width in a shorter time than above. This can further improve the yield in the manufacture of battery electrodes.

In the above aspect, preferably, the device further includes a width measuring device to measure the coating width, and the coating width controller determines the pressure reduction degree according to the coating width measured by the width measuring device.

According to this configuration, the feedback control is performed based on a measurement value of the coating width. Thus, the coating width of the electrode paste is more accurately controllable to the desired width.

In the above aspect, preferably, the device further includes a viscosity measuring mechanism to measure a viscosity of the electrode paste; and; the coating width controller sets the pressure reduction degree according to the viscosity of the electrode paste measured by the viscosity measuring mechanism before the start of coating the electrode paste on the current collector sheet.

According to this configuration, it is possible to control the coating width of the electrode paste to the desired width from the start of coating. Therefore, even a coating start portion of the current collector sheet applied with the electrode paste can be used for battery electrodes. This can further increase the yield in the manufacture of battery electrodes,

### Effects of the Invention

According to the battery electrode manufacturing method and the battery electrode manufacturing device of the invention, the yield in the manufacture of battery electrodes can be increased.

### BRIEF DESCRIPTION OF THE DRAWINGS

FIG. 1 is a configuration view of a manufacturing device in Example 1;

FIG. 2 is a top view of a die and a pressure reducing chamber of FIG. 1;

FIG. 3 is a graph showing one example of a relationship between pressure reduction degree and coating width;

FIG. 4 is a graph showing one example of a relationship between inverter frequency of a blower and the pressure reduction degree;

FIG. 5 is a comparative graph showing a time required until a coating width is stabilized to a desired width;

FIG. 6 is a configuration view of a manufacturing device in Example 2;

FIG. 7 is a view showing a clearance between a backup roller and a pressure reducing chamber;

FIG. 8 is a graph showing one example of a relationship between the clearance and the pressure reduction degree;

FIG. 9 is a comparative graph showing a time required until a coating width is stabilized to a desired width;

FIG. 10 is a configuration view of a manufacturing device in Example 3;

FIG. 11 is a graph showing one example of a relationship between viscosity and coating width;

FIG. 12 is a graph showing evaluation results of the coating width in a case of unchanged pressure reduction degree;

FIG. 13 is a graph showing evaluation results of the coating width in a case of changed pressure reduction degree; and

FIG. 14 is a view showing a problem in a conventional art.

### MODE FOR CARRYING OUT THE INVENTION

A detailed description of a preferred embodiment of the present invention will now be given referring to the accompanying drawings.

### EXAMPLE 1

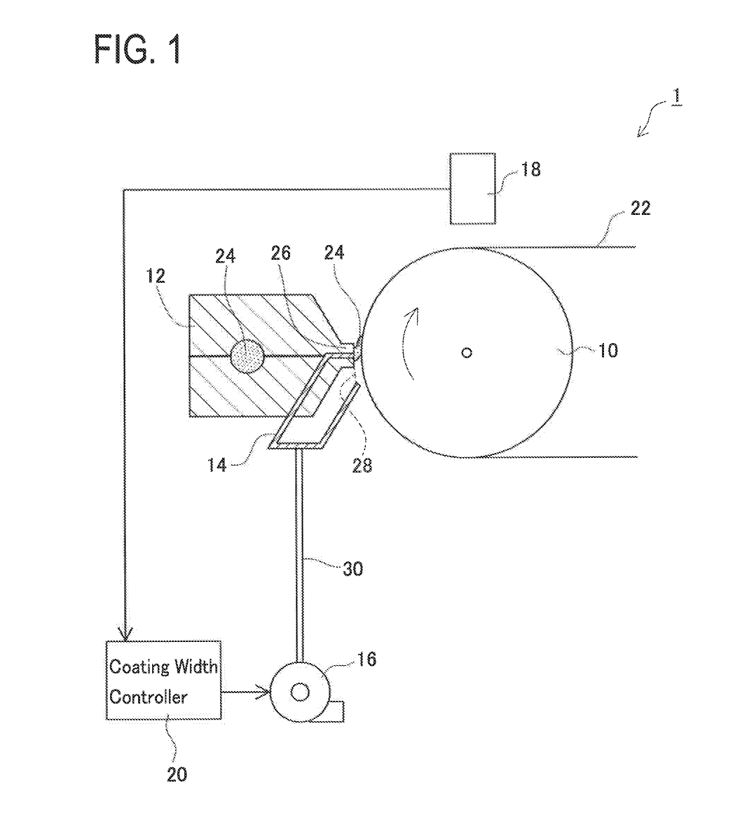

The configuration of a battery electrode manufacturing device 1 in Example 1 will be first explained below. FIG. 1 is a configuration view of the battery electrode manufacturing device 1 in Example 1.

As shown in FIG. 1, the manufacturing device 1 in Example 1 includes a backup roller 10, a die 12, a pressure reducing chamber 14, a blower 16, a width measuring device 18, a coating width controller 20, and others. This manufacturing device 1 in Example 1 is available for manufacturing an electrode of a secondary battery, for example.

The backup roller 10 is a columnar rotating body serving to feed a strip-shaped current collector sheet 22 wound on the roller 10. This roller 10 is rotated in a direction indicated by an arrow shown in FIG. 1 to feed the sheet 22 in the arrow indicating direction in FIG. 1.

The die 12 is a means to discharge electrode paste 24 supplied from a tank or the like not shown out of a lip portion 26 provided at a tip of the die 12, thereby coating the current collector sheet 22 with the electrode paste 24. This electrode paste 24 is a paste-like electrode material containing an electrode rode active material.

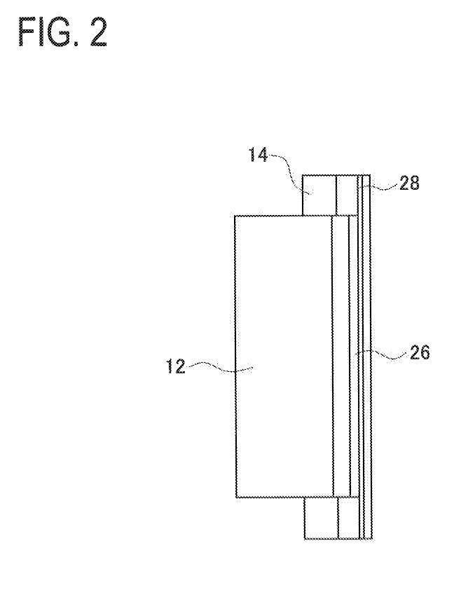

The pressure reducing chamber 14 is a means to reduce the pressure between the backup roller 10 and the lip portion 26 of the die 12. In this example, the pressure reducing chamber 14 reduces the pressure on the upstream side of the electrode paste 24 being coated on the current collector sheet 22 in the feeding direction of the sheet 22. The pressure reducing chamber 14 is placed at the tip of the die 12 so that a suction port 28 of the pressure reducing chamber 14 is located on the more upstream side in the feeding direction of the sheet 22 than the center of the lip portion 26 of the die 12 in the vertical direction in FIG. 1. FIG. 2 is a top view of the die 12 and the pressure reducing chamber 14 of FIG. 1.

The blower 16 is a means to suck the interior of the pressure reducing chamber 14 through a tube 30 to thereby generate a negative pressure in the chamber 14.

The width measuring device 18 is a means to measure the coating width of the electrode paste 24 coated on the current collector sheet 22. This width measuring device 18 is placed in a position on the more downstream side than the lip portion 26 of the die 12 in the feeding direction of the current collector sheet 22. Herein, the coating width of the electrode paste 24 indicates the width of the electrode paste 24 in a short side of the sheet 22 (in a direction perpendicular the feeding direction of the current collector sheet 22) when the paste 24 is coated on the current collector sheet 22.

The coating width controller 20 is a means to change the pressure reduction degree of the pressure reducing chamber 14 to control the coating width of the electrode paste 24. In Example 1, the coating width controller 20 changes the inverter frequency of the blower 16 to change a suction amount per unit time (the number of rotations per unit time), thereby changing the pressure reduction degree of the pressure reducing chamber 14.

A battery electrode manufacturing method using the above configured manufacturing device 1 will be explained below.

In the manufacturing method in Example 1, in the manufacturing device 1, the number of rotations of the backup roller 10, the amount of the electrode paste 24 to be discharged or ejected from the die 12, and other conditions are set to prescribed values. The electrode paste 24 is thus discharged from the lip portion 26 of the die 12 toward the current collector sheet 22 which is supported on and fed by the backup roller 10 to coat the electrode paste 24 on the current collector sheet 22.

At that time the coating width of the electrode paste 24 coated on the current collector sheet 22 is measured by the width measuring device 18. Information of measurement results of the coating width of the electrode paste 24 is transmitted from the width measuring device 18 to the coating width controller 20.

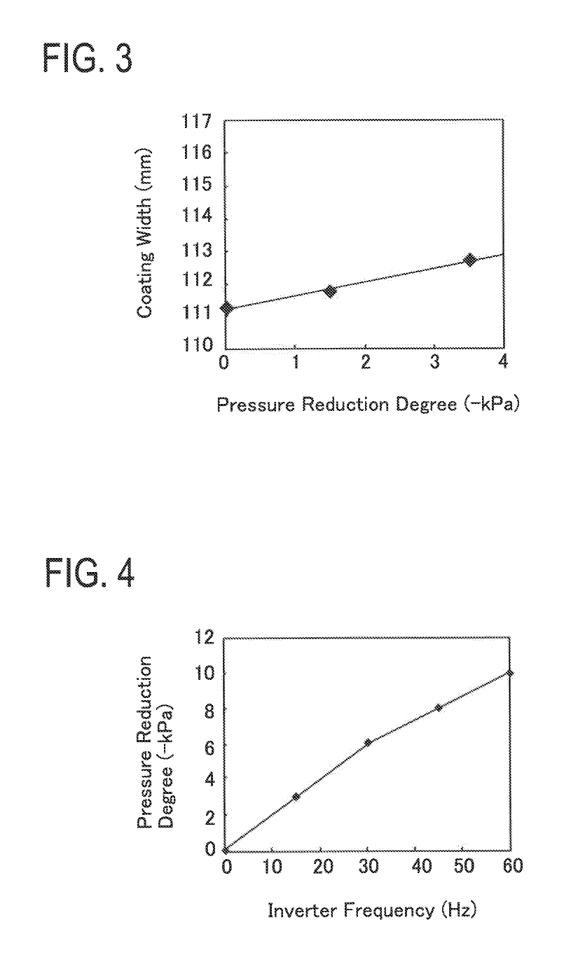

Upon receipt of the measurement results of the coating width of the electrode paste 24 obtained from the width measuring device 18, the coating width controller 20 makes a calculation, using a calculating expression and a relationship diagram defining a relationship between the pressure reduction degree of the pressure reducing chamber 14 and the coating width of the electrode paste 24, to determine a target value of the pressure reduction degree of the pressure reducing chamber 14 at which the electrode paste 24 can be formed with the desired coating width. One example of the calculating expression and the relationship diagram, which define the relationship between the pressure reduction degree of the pressure reducing chamber 14 and the coating width of the electrode paste 24, is expressed as the following formula and FIG. 3. It is to be noted that X represents the pressure reduction degree of the pressure reducing chamber 14 and Y represents the coating width of the electrode paste 24.

Y=0.4154×X+111.2 Formula 1:

Subsequently, based on the determined target value of the pressure reduction degree of the pressure reducing chamber 14, the coating width controller 20 calculates a set value of the inverter frequency of the blower 16 from a calculating expression or a relationship diagram, which define the relationship between the pressure reduction degree and the inverter frequency of the blower 16. FIG, 4 shows one example of the relationship diagram defining the pressure reduction degree of the pressure reducing chamber 14 and the inverter frequency of the blower 16.

The coating width controller 20 sets the inverter frequency of the blower to the set value calculated as above and then changes the suction amount per unit time of the blower 16 to set the suction amount to the target value. Accordingly, while the pressure reduction degree of the pressure reducing chamber 14 is changed and set to the target value to control the coating width of the electrode paste 24 to the desired width, the paste 24 can be coated on the current collector sheet 22.

According to Example 1 as above, the inverter frequency of the blower 16 is adjusted to change the pressure reduction degree of the pressure reducing chamber 14. Thus, the coating width of the electrode paste 24 can reach the desired width in a short time without causing a conventional problem that much time is required until the pressure in the lip portion 26 of the die 12 becomes stable.

Therefore, a portion of the current collector sheet 22 coated with the electrode paste 24 having a coating width narrower than the desired width can be shortened. That is, an unusable portion of the current collector sheet 22 for battery electrode can be reduced. The yield in the manufacture of battery electrodes can thus be increased.

Since it is only necessary to adjust the inverter frequency of the blower 16, a simple configuration can be achieved.

The feedback control is executed based on a measurement value of the coating width of the electrode paste 24 measured by the width measuring device 18. This enables more accurate control of the coating width of the electrode paste 24 to the desired width.

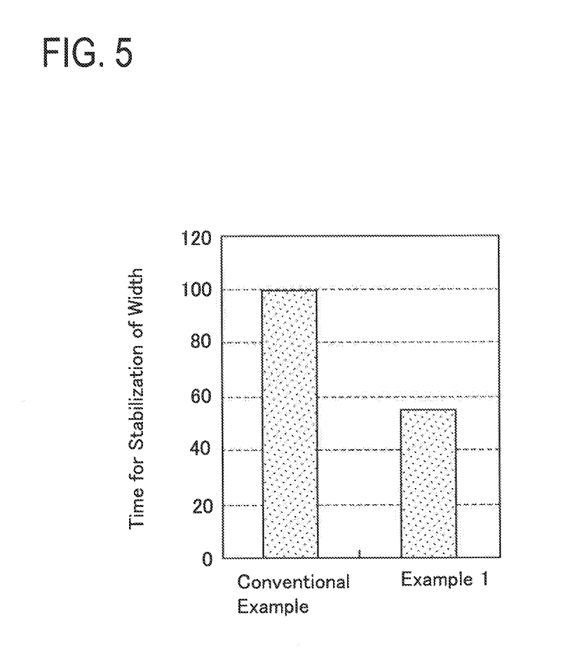

FIG. 5 is a graph showing evaluation results of the time required until the coating width of the electrode paste 24 reaches and stabilizes at the desired width. This graph showing evaluation results on the conventional example and Example 1. The conventional example shows a case where the gap between the die 12 and the current collector sheet 22 is adjusted to control the coating width of the electrode paste 24.

As shown in FIG, 5, assuming that the time required until the coating width of the electrode paste 24 reaches and stabilizes at the desired width (“Time for Stabilization of Width” in FIG. 5) is 100 in the conventional example, this time is about 55 in Example 1. This reveals that the time required until the coating width of the electrode paste 24 becomes the desired width and stable in Example 1 could be shortened than in the conventional example.

### EXAMPLE 2

Example 2 will be described below. In the following description, identical or similar parts to those in Example 1 are given the same reference signs but not explained. Differences from Example 1 are focused on.

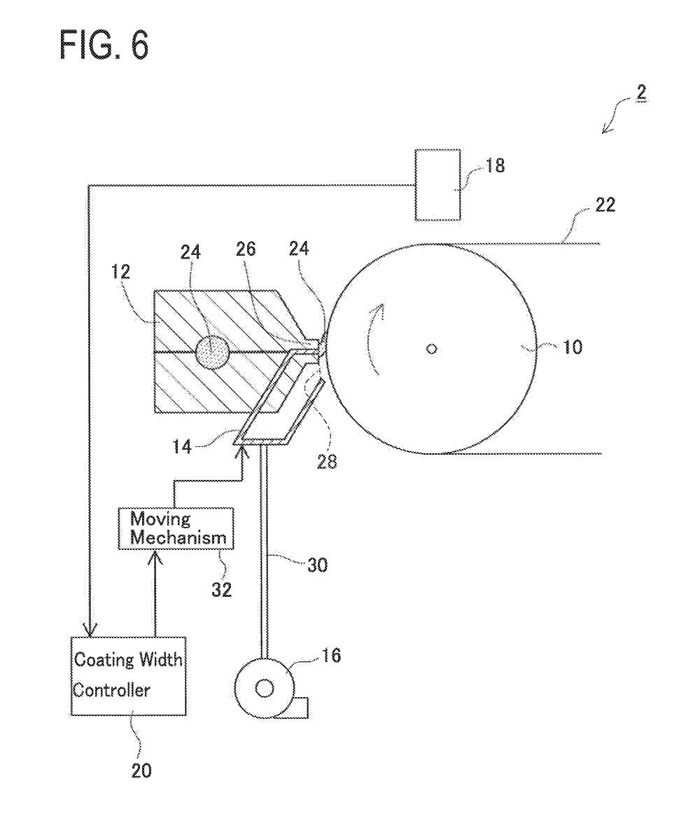

The configuration of a battery electrode manufacturing device 2 in Example 2 is first explained. FIG. 6 is a configuration view of the manufacturing device 2 in Example 2. This device 2 includes a moving mechanism 32, differently from the manufacturing device 1 in Example 1.

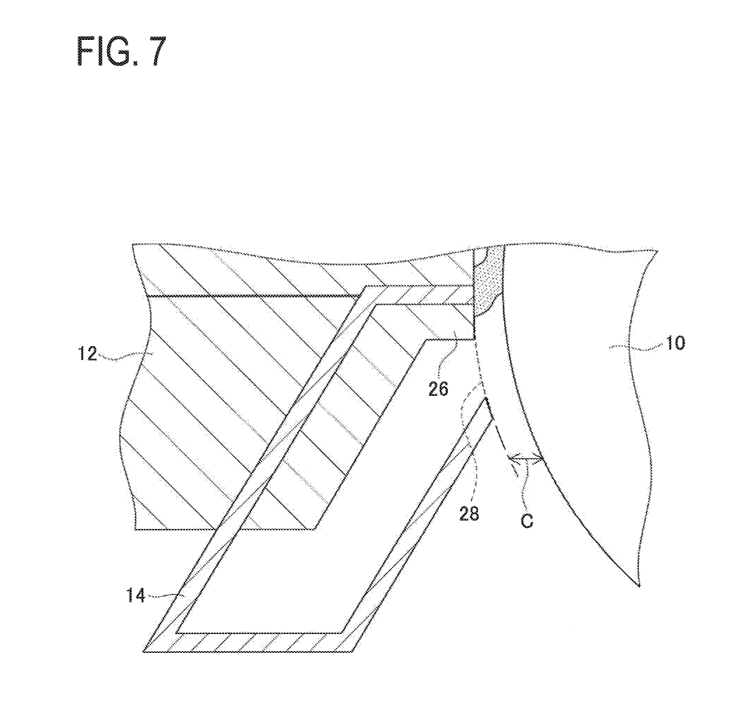

The moving mechanism 32 is a drive means to move the pressure reducing chamber 14. By moving the pressure reducing chamber 14 by the moving mechanism 32, a clearance C (see FIG. 7) between the backup roller 10 and the pressure reducing chamber 14 is changed.

A battery electrode manufacturing method in Example 2 using the above configured manufacturing device 2 is explained below.

According to the manufacturing method in Example 2, differently from the manufacturing method in Example 1, the coating width controller 20 causes the moving mechanism 32 to move the pressure reducing chamber 14 while keeping the inverter frequency of the blower 16 at a constant value, thereby changing the clearance between the backup roller 10 and the pressure reducing chamber 14 to change the pressure reduction degree of the chamber 14.

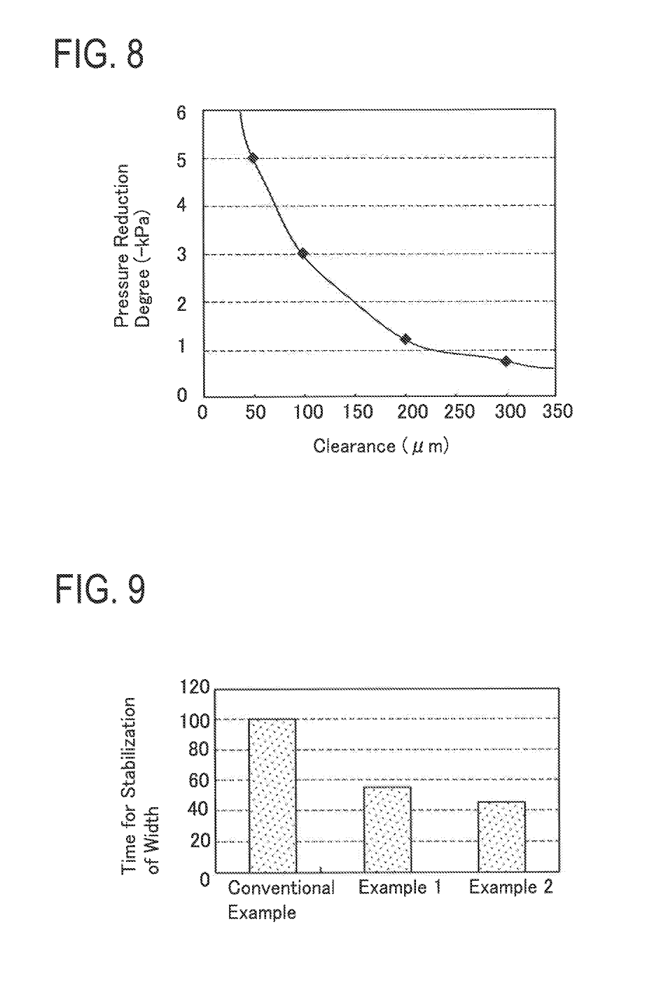

To be concrete, from a relationship diagram or a calculating expression, which indicate the relationship between the pressure reduction degree of the pressure reducing chamber 14 and the clearance C, the coating width controller 20 calculates a set value of the clearance C needed to adjust the pressure reduction degree of the pressure reducing chamber 14 to a target value. FIG. 8 shows one example of the relationship diagram defining the relationship between the pressure reduction degree of the pressure reducing chamber 14 and the clearance C. The controller 20 drives the moving mechanism 32 to move the pressure reducing chamber 14 so that the clearance C coincides with the set value calculated as above. The method for determining a target value of the pressure reduction degree of the pressure reducing chamber 14 is identical to that in Example 1.

Accordingly, while the pressure reduction degree of the pressure reducing chamber 14 is changed and set to the target value to control the coating width of the electrode paste 24 to the desired width, the paste 24 can be coated on the current collector sheet 22.

According to Example 2, as above, the clearance C is changed to change the pressure reduction degree of the pressure reducing chamber 14. Thus, the coating width of the electrode paste 24 reaches and stabilized at the desired width without causing a problem that it takes long until the pressure in the lip portion 26 of the die 12 becomes stable as in the conventional example.

The above configuration can shorten a portion of the current collector sheet 22 coated with the electrode paste 24 with a coating width narrower than the desired width. This can reduce an unusable portion of the current collector sheet 22 for battery electrode. Thus, the yield in the manufacture of battery electrodes can be increased.

The moving direction of the pressure reducing chamber 14 by the moving mechanism 32 may be set to right-and-left directions or up-and-down directions in FIG. 6 as well as a radial direction of the backup roller 10.

FIG. 9 is a graph showing evaluation results of the time required until the coating width of the electrode paste 24 reaches and stabilizes at the desired width. This graph shows evaluation results in the conventional example, Example 1, and Example 2. As shown in FIG. 9, assuming that the time required until the coating width of the electrode paste 24 reaches and stabilizes at the desired width (“Time for Stabilization of Width” in FIG. 9) is 100 in the conventional example, this time is about 45 in Example 2. This reveals that the time required until the coating width of the electrode paste 24 reaches and stabilizes at the desired width could be shortened than in the conventional example and Example 1. According to Example 2, therefore, it is found that the yield in the manufacture of battery electrodes can be increased more than in Example 1.

For coating the electrode paste 24 on the current collector sheet 22, Examples 1 and 2 may be used selectively alone or in combination. For instance, when the pressure reduction degree of the pressure reducing chamber 14 is to be changed, it is conceivable to simultaneously change the inverter frequency of the blower 16 as in Example 1 and change the clearance C as in Example 2 or to selectively change them according to a coating condition.

### EXAMPLE 3

Example 3 will be described below. In the following description, identical or similar parts to those in Examples 1 and 2 are given the same reference signs but not explained. Differences from Examples 1 and 2 are focused on. The aforementioned Examples 1 and 2 show the cases where the feedback control of the coating width of the electrode paste 24 is executed based on measurement results of the width measuring device 18 measured at the time of coating the electrode paste 24 on the current collector sheet 22. On the other hand, Example 3 shows a case where the feed forward control of the coating width of the electrode paste 24 is performed before the start of coating the electrode paste 24 on the current collector sheet 22, and then the coating is started.

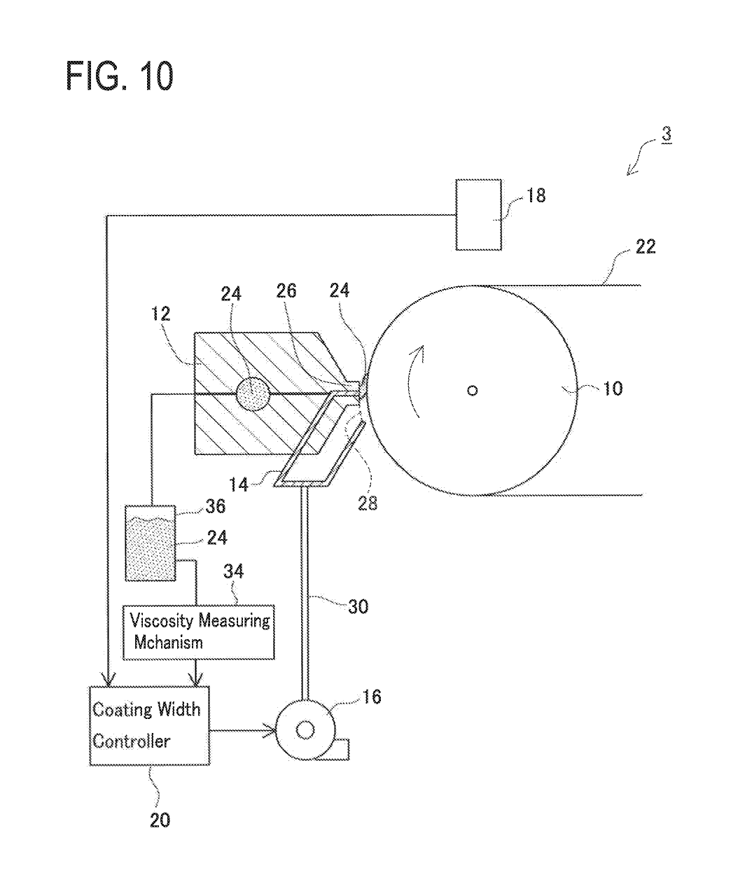

FIG. 10 is a configuration view of a manufacturing device in Example 3. The manufacturing device in Example 3, differently from Examples 1 and 2, includes a viscosity measuring mechanism 34.

The viscosity measuring mechanism 34 is a means to measure the viscosity of the electrode paste 24 stored in a paste tank 36. The information of the viscosity measured by the viscosity measuring mechanism 34 is transmitted to the coating width controller 20.

A battery electrode manufacturing method using the manufacturing device configured as above is explained below.

Before the start of coating the electrode paste 24 on the current collector sheet 22, firstly, the viscosity of the electrode paste 24 stored in the paste tank 36 is measured by the viscosity measuring mechanism 34. A measurement result of the viscosity of the electrode paste 24 is transmitted from the viscosity measuring mechanism 34 to the coating width controller 20.

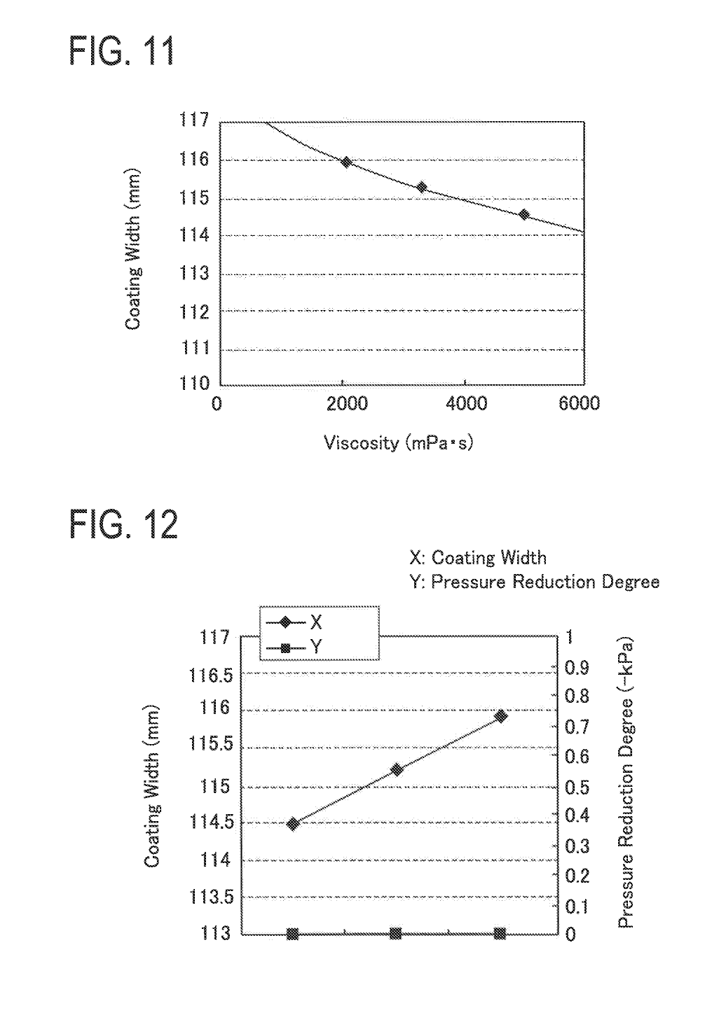

Based on the measurement result of the viscosity of the electrode paste 24 obtained from the viscosity measuring mechanism 34, the coating width controller 20 then calculates an expected coating width of the electrode paste 24 by using a relationship diagram or a calculating expression each defining the relationship between the viscosity and the coating width of the electrode paste 24. FIG. 11 shows one example of the relationship diagram relating to the viscosity and the coating width of the electrode paste 24.

Based on the expected coating width of the electrode paste 24 calculated above, by using the calculating expression or relationship diagram defining the relationship between the pressure reduction degree of the pressure reducing chamber 14 and the coating width of the electrode paste 24, the coating width controller 20 determines a target value of the pressure reduction degree of the chamber 14 at which the electrode paste 24 can be formed with the desired width in a similar manner to that in the aforementioned Example 1.

The coating width controller 20 changes and sets the pressure reduction degree of the pressure reducing chamber 14 to the target value determined above. The method for changing the pressure reduction degree of the pressure reducing chamber 14 may be selected from the method for changing the inverter frequency of the blower 16 as in the aforementioned Example 1 and the method for changing the clearance C between the pressure reducing chamber 14 and the backup roller 10 by the moving mechanism 32 as in the aforementioned Example 2.

The pressure reduction degree of the pressure reducing chamber 14 is set in advance to the target value as above, and then coating of the electrode paste 24 on the current collector sheet 22 is started.

Accordingly, from the start of coating, the electrode paste 24 of the desired coating width can be coated on the surface of the current collector sheet 22. Thus, the current collector sheet 22 coated with the electrode paste 24 can also be used from a coating-start portion for battery electrodes. According to Example 3, therefore, the yield in the manufacture of battery electrodes can be increased more than in Examples 1 and 2.

It is to be noted that during coating of the electrode paste 24 on the current collector sheet 22 after starting as above, the feedback control of the coating width of the electrode paste 24 may be executed based on the measurement results of the width measuring device 18 measured as in the aforementioned Examples 1 and 2.

The above example uses the viscosity measuring mechanism 34, but the invention is not limited thereto. The coating width controller 20 may be arranged to change the pressure reduction degree of the pressure reducing chamber 14 based on a result of the viscosity of the electrode paste 24 measured outside the manufacturing device 3.

<Evaluation Results of Coating Width>

Evaluation was made to check the advantageous effects obtained when the pressure reduction degree of the pressure reducing chamber 14 was changed to control the coating width of the electrode paste 24 according to the invention.

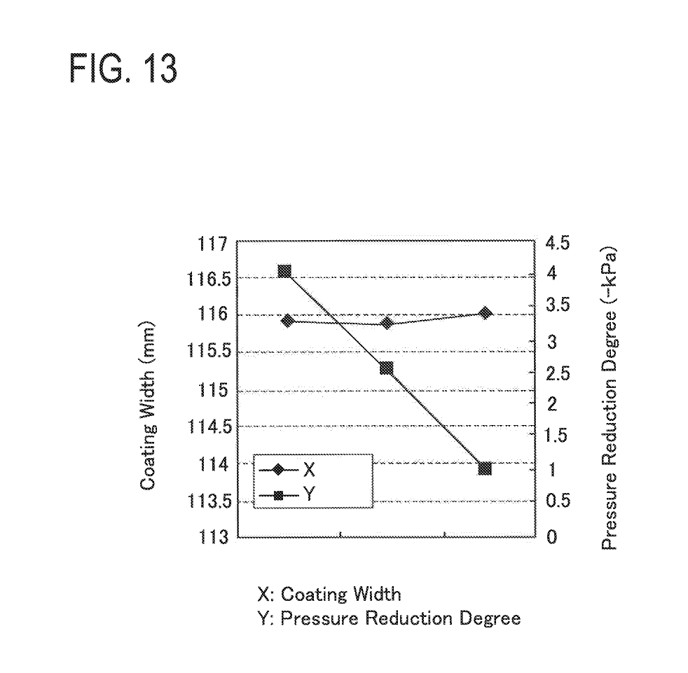

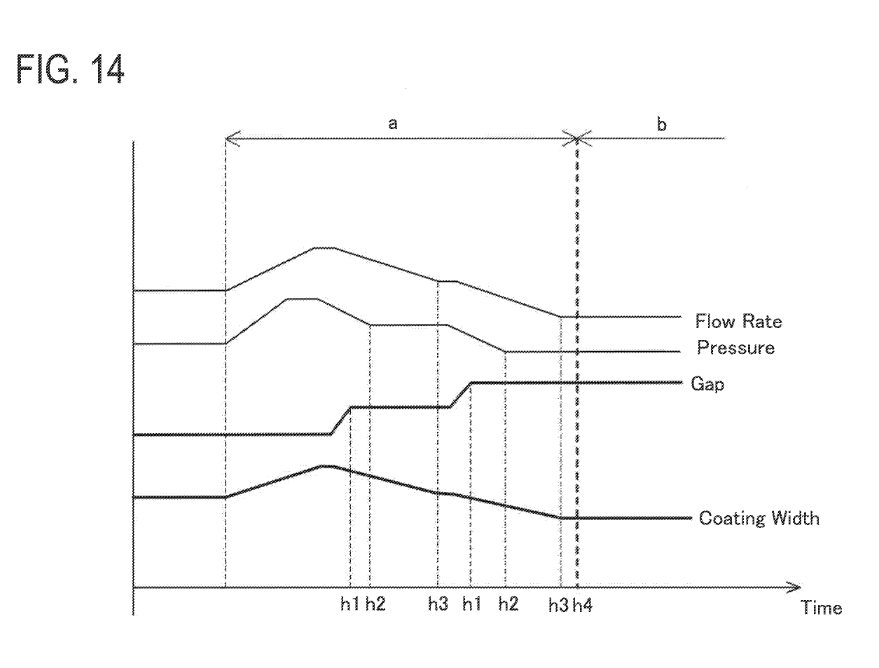

FIGS. 12 and 13 show results of the evaluation. FIG. 12 shows evaluation results obtained when the pressure reduction degree of the pressure reducing chamber 14 was not 1 5 changed and the coating width of the electrode paste 24 was not controlled. FIG. 13 shows evaluation results obtained when the pressure reduction degree of the pressure reducing chamber 14 was changed and thereby the coating width of the electrode paste 24 was controlled.

As shown in FIG. 12, when the pressure reduction degree of the pressure reducing chamber 14 was not changed so that the coating width of the electrode paste 24 was not controlled, the coating width of the electrode paste 24 varied in a range from 145 mm to 115.9 mm and did not become stable. In contrast, as shown in FIG. 13, when the pressure reduction degree of the pressure reducing chamber 14 was changed so that the coating width of the electrode paste 24 was controlled as in the present invention, the coating width of the electrode paste 24 fell within a range from 115.8 mm to 116.0 mm and became stable.

The above embodiments are mere examples and the invention is not limited thereto. The present invention may be embodied in other specific forms without departing from the essential characteristics thereof.

### REFERENCE SIGNS LIST

1 Manufacturing device
2 Manufacturing device
3 Manufacturing device
10 Backup roller
12 Die
14 Pressure reducing chamber
16 Blower
18 Width measuring device
20 Coating width controller
22 Current collector sheet
24 Electrode paste
32 Moving mechanism
34 Viscosity measuring mechanism

1. A battery electrode manufacturing method for coating electrode paste on a current collector sheet to be fed, the method comprising the steps of:
placing a pressure reducing chamber at a tip of a die for discharging the electrode paste; and
changing a distance between the pressure reducing chamber and the current collector sheet to change a pressure reduction degree of the pressure reducing chamber to control a coating width of the electrode paste.

2. The battery electrode manufacturing method according to claim 1, wherein the method includes changing a suction amount of a blower connected to the pressure reducing chamber to change the pressure reduction degree.

3. (canceled)

4. The battery electrode manufacturing method according to claim 1, wherein the method includes measuring the coating width and determining the pressure reduction degree according to the measured coating width.

5. The battery electrode manufacturing method according to claim 1, wherein the method includes measuring a viscosity of the electrode paste before the start of coating the electrode paste on the current collector sheet and setting the pressure reduction degree according to the measured viscosity.

6. A battery electrode manufacturing device for coating electrode paste on a current collector sheet to be fed, the device comprising:
a die to discharge the electrode paste;
a pressure reducing chamber placed at a tip of the die; and
a coating width controller to change a distance between the pressure reducing chamber and the current collector sheet to change a pressure reduction degree of the pressure reducing chamber to control a coating width of the electrode paste.

7. The battery electrode manufacturing device according to claim 6, wherein the coating width controller changes a suction amount of a blower connected to the pressure reducing chamber to change the pressure reduction degree.

8. (canceled)

9. The battery electrode manufacturing device according to claim 6, wherein the device further includes a width measuring device to measure the coating width, and
the coating width controller determines the pressure reduction degree according to the coating width measured by the width measuring device.

10. The battery electrode manufacturing device according to claim 6, wherein the device further includes a viscosity measuring mechanism to measure a viscosity of the electrode paste; and;
the coating width controller sets the pressure reduction degree according to the viscosity of the electrode paste measured by the viscosity measuring mechanism before the start of coating the electrode paste on the current collector sheet.
